(19) United States
(12) Patent Application Publication
(10) Pub. No.: US 2004/0154362 A1
(43) Pub. Date: Aug. 12, 2004

(54) Vehicle door operating apparatus

(75) Inventors: Katsutoshi Fukunaga, Chiryu-shi (JP); Makoto Suzumura, Chita-shi (JP); Shigehiro Oya, Toyoake-shi (JP); Akira Muramatsu, Chiryu-shi (JP); Yukinobu Kunimatsu, Aichi-ken (JP)

Correspondence Address: BURNS DOANE SWECKER & MATHIS L L P, POST OFFICE BOX 1404, ALEXANDRIA, VA, 22313-1404, US

(73) Assignee: AISIN SEIKI KABUSHIKI KAISHA

(21) Appl. No.: 10/720,171

(22) Filed: Nov. 25, 2003

(30) Foreign Application Priority Data
Nov. 25, 2002 (JP) 2002-341157

(51) Int. Cl. E05B 13/00

(52) U.S. Cl. 70/208; 70/257

(57) ABSTRACT

A vehicle door operating apparatus operated for opening a vehicle door, comprises an opening operation member provided at the vehicle door outside of a compartment and operated for rotating a latch mechanism of the vehicle door relative to a vehicle body from an engaging condition to a disengaging condition, and a vehicle door lock apparatus provided inside of the compartment relative to the opening operation member of the vehicle door and having an unlocked condition that the latch mechanism is rotatable and a locked condition that the latch mechanism is not rotatable based on at least an operation of the opening operation member. The vehicle door operating apparatus further includes an input member provided at the vehicle door lock apparatus for receiving an operating force from the opening operation member provided inside of the compartment, and a cable provided for transmitting the operating force from the opening operation member to the input member.

This application is based on and claims priority under 35 U.S.C. § 119 with respect to Japanese Application No. 2002-341157 filed on Nov. 25, 2002, the entire content of which is incorporated herein by reference.

### FIELD OF THE INVENTION

This invention generally relates to a vehicle door operating apparatus. More particularly, the present invention pertains to an apparatus to be operated for opening the vehicle door.

### BACKGROUND OF THE INVENTION

A known vehicle door operating apparatus is disclosed in Japanese Patent Laid-Open Publication No. 2002-242508. The disclosed vehicle door operating apparatus includes a vehicle door lock apparatus (hereinafter called door lock apparatus) provided in the vehicle door (hereinafter called door) for switching a locked condition and an unlocked condition thereof, an outside handle provided at a outer surface of a panel of the vehicle door and operated for rotating a latch mechanism of the door, and a cable for transmitting an operating force from the outside handle to the door lock apparatus. The cable including a curbed portion is provided bypassing within the door.

According to the known vehicle door lock apparatus, however, the cable is provided approximately flatly bypassing along the door surface (e.g. the cable extends in vertical direction and in the longitudinal direction of the vehicle along an approximately flat surface within the door provided at the side surface of the vehicle body), so that the cable may flip-flop in the thickness direction of the door. As a result, noise may be generated due to interference between the cable and the panel and the like of the door. To prevent the flip-flop movement of the cable in the thickness direction of the door, an additional clamp and the like may be applied to hold the cable stably. However, this configuration needs additional components within the door, as a result, the construction within the door becomes more complex.

The present invention therefore seeks to provide a vehicle door operating apparatus to solve aforementioned problems by improving the configuration for stably supporting the cable provided within the door without applying the complex construction to the door.

### SUMMARY OF THE INVENTION

According to a current invention, a vehicle door operating apparatus operated for opening a vehicle door, comprising an opening operation member provided at the vehicle door outside of a compartment and operated for rotating a latch mechanism of the vehicle door relative to a vehicle body from an engaging condition to a disengaging condition, and a vehicle door lock apparatus provided inside of the compartment relative to the opening operation member of the vehicle door and having an unlocked condition that the latch mechanism is rotatable and a locked condition that the latch mechanism is not rotatable based on at least an operation of the opening operation member,

In addition, according to the current invention, the vehicle door operating apparatus for opening the vehicle door further includes an input member provided at the vehicle door lock apparatus for receiving an operating force from the opening operation member provided inside of the compartment, and a cable provided for transmitting the operating force from the opening operation member to the input member.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements and wherein:

FIG. 1 illustrates a cross sectional view of a vehicle door when a vehicle door operating apparatus is provided within the vehicle door according to the current invention;

FIG. 2 illustrates a flat view of the inside of the vehicle door when the vehicle door operating apparatus provided within the vehicle door according to the current invention;

FIG. 3 illustrates a flat view of the vehicle door lock apparatus according to the current invention;

FIG. 4 illustrates a perspective view of the vehicle door operating apparatus according to the current invention;

FIG. 5 illustrates a view (a cross sectional view within the vehicle door) used for explaining an assembling process of the vehicle door operating apparatus within the vehicle door according to the current invention; and

FIG. 6 illustrates a view (a flat view within the vehicle door) used for explaining an assembling process of the vehicle door operating apparatus within the vehicle door according to the current invention.

### DETAILED DESCRIPTION OF THE INVENTION

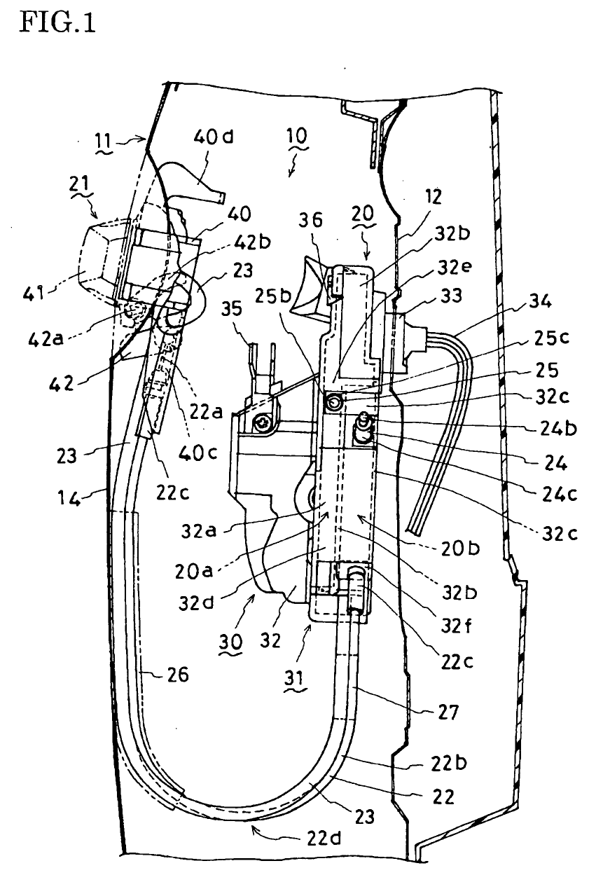

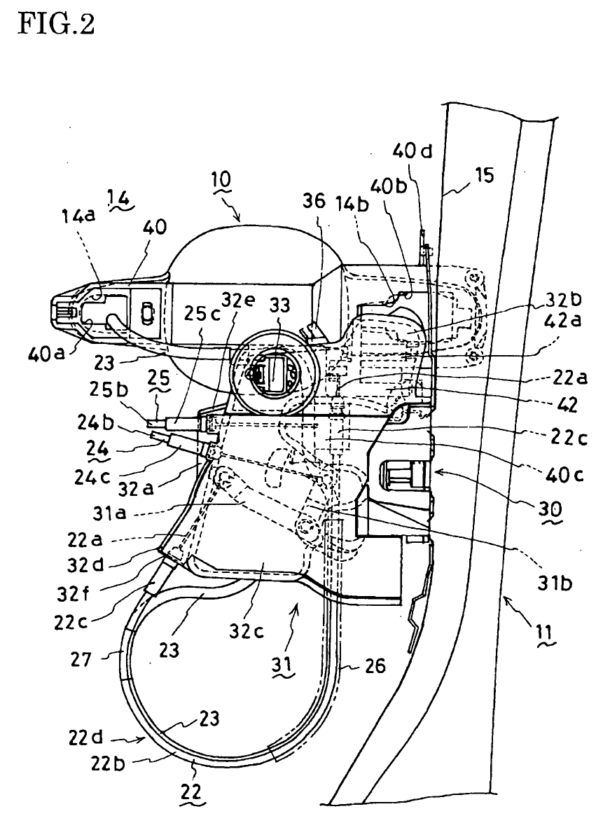

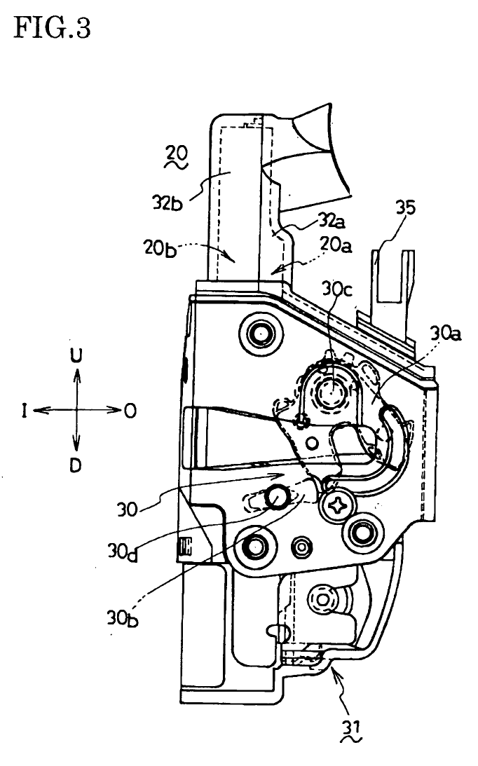

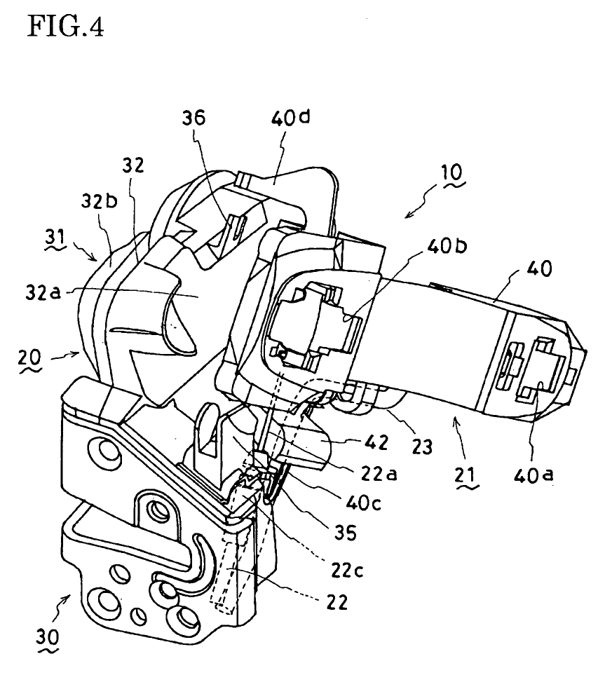

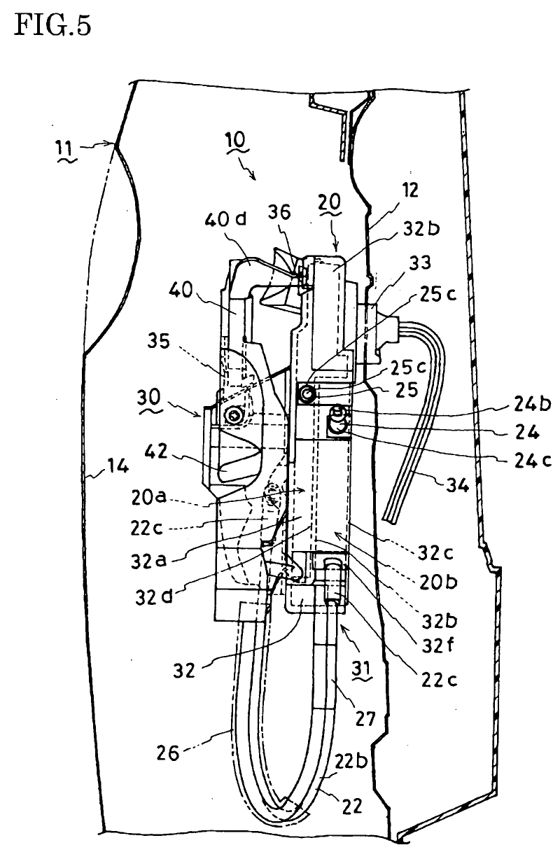

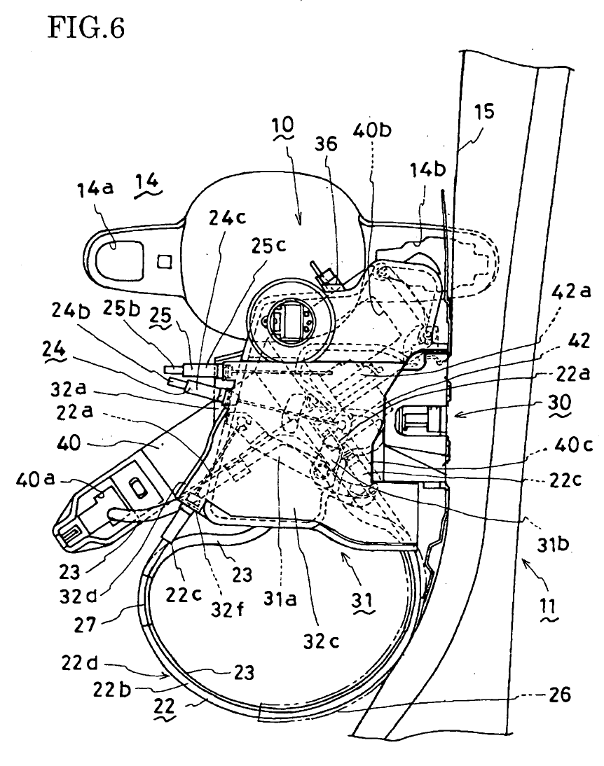

A preferred embodiment of the present invention will be described hereinbelow in detail with reference to the accompanying drawings. FIG. 1 and FIG. 2 illustrate a door operating apparatus 10 (vehicle door operating apparatus) provided within a door 11 (vehicle door). The door 11 is a swing-type door provided on a side surface of the vehicle, and FIG. 1 illustrates a cross-section of the door 11 viewed from the front of the vehicle toward the front of the vehicle. FIG. 2 illustrates a flat-view of the inner configuration of the door 11 viewed from inside of the compartment. FIG. 3 illustrates a flat-view of a door lock apparatus 20 (vehicle door lock apparatus) viewed from the rear of the vehicle to the front of the vehicle. FIG. 4 illustrates a perspective view of the door operating apparatus 10. FIG. 5 and FIG. 6 illustrate the door lock apparatus 20 of the door operating apparatus 10 assembled to the door 11 which corresponds to FIG. 1 and FIG. 2. In FIG. 4, a three-dimensional vector is shown by allows with letters U (upper), D (lower), F (front), R (rear), O (outboard) and I (inboard). In FIG. 2 and FIG. 6, two-dimensional vectors are shown by allows with letters U (upper), D (lower), F (front) and R (rear). In FIG. 1, FIG. 3 and FIG. 5, two-dimensional vectors are shown by allows with letters U (upper), D (lower), O (outboard) and I (inboard).

The door operating apparatus 10 includes the door lock apparatus 20, an outside handle 21 (opening operation member), a cable 22 (cable) and a harness 23 (wire harness). The door lock apparatus 22 and the outside handle 21 are connected with the cable 22 and the harness 23.

The door lock apparatus 20 is roughly comprised of a latch mechanism 30 (latch mechanism) section and a lock mechanism 31 section. A housing 32 integrally houses the latch mechanism 30 and the lock mechanism 31 for preventing these mechanisms from being eroded by water or being operated improperly. The latch mechanism 30 having a known configuration includes a latch 30a (shown in FIG. 3) for engaging or disengaging relative to a striker (not shown) and a pawl 30b (shown in FIG. 3) for controlling a pivotally movement of the latch 30a. The latch 30a is pivotally supported by a shaft 30c extending in longitudinal direction which is a direction of a flat surface of the door (flat surface extending in longitudinal direction and vertical direction of the vehicle), and the pawl 30b is rotatably supported by a shaft 30d extending in longitudinal direction of the vehicle. The lock mechanism 31 having a known configuration includes a lever, a link, a motor for actuating the lever, a terminal base at which the motor is electrically connected and the like (not shown).

The housing 32 includes a case 32a covering a vehicle outboard side in vehicle width direction (hereinafter called the vehicle outboard side) of the door lock apparatus 20, and a first cover 32b and a second cover 32c (inner cover) covering a vehicle inboard side in vehicle width direction (hereinafter called the vehicle inboard side) of the door lock apparatus 20. As shown in FIG. 1 and FIG. 2, an upper portion of the first cover 32b forms an outer shape of the upper and the vehicle inboard side of the housing 32, and lower portion of the first cover 32b extends in stepped form from the upper portion thereof toward the vehicle outboard side. The second cover 32c forms an outer shape of the lower and the vehicle inboard side of the housing 32. Thus, the door lock apparatus 20 includes a space 20a and a space 20b formed by the case 32a, the first cover 32b and the second cover 32c, and these spaces are provided in line in vehicle width direction. The electrical components of the lock mechanism 32 such as the motor, the terminal base and the like are mainly housed in the space 20a. The lever and the like of the lock mechanism 31 are mainly housed in the space 20b.

A configuration of the inside of the space 20b will be explained based on FIG. 2. An outside open lever 31 a (input member) rotatably supported by the second cover 32c is provided in the space 20b. In other word, the outside open lever 31a is provided at the vehicle inboard side of the door lock apparatus 20. Specifically, the outside open lever 31a is provided within the vehicle inboard area relative to the shaft 30c, not the most inner portion of the door lock apparatus 20 in the thickness direction of the vehicle. Furthermore, the outside open lever 31a is supported by a member which is located within the vehicle inboard area relative to the shaft 30c, such as the second cover 32c. In the embodiment of the current invention, the outside open lever 31a is rotatably supported by the second cover 32s, however, the configuration is not limited. Alternatively, the outside open lever 31a can be rotatably supported by the first cover 32b on the vehicle inboard surface thereof (in the space 20b), or by the case 32a, as long as these members are located at the vehicle inboard side relative to the shaft 30c. According to the embodiment of the current invention, the outside open lever 31 is rotatably supported by the second cover 32a, so that a structure for supporting the outside open lever 31 becomes more simplified. The direction of a shaft, at which the outside open lever 31a is rotatably supported, is approximately the same as the thickness direction of the door 11 (approximately the vehicle width direction), in other word, being approximately upright relative to the shaft 30c. Thus, the outside open lever 31a rotates on a flat surface within the vehicle inboard side relative to the shaft 30c. The cable 22 is connected to the outside open lever 31a for transmitting an operating force from the outside handle 21.

An inside open lever 31b provided in the space 20b is supported by the shaft which supports the outside open lever 31a; however, each levers can be supported with different shafts respectively. A cable 24 is connected to the inside open lever 31b for transmitting an operating force from the inside handle (not shown) provided at an inner panel 12 side. An inside lock lever (not shown) and the like are provided in the space 20b. The inside lock lever is connected to a lock knob (not shown) provided at the vehicle inboard side of the door 11 with a cable 25; however, operations of these members will not be explained.

The cable 22 includes an inner cable 22a and an outer cable 22b, and caps 22c are provided at each end of the outer cable 22b. The inner cable is made of metal, and the outer cable 22b and the caps 22c are made of resin. As shown in FIG. 1 and FIG. 2, a waterproofing wall 32d is formed at the case 32a for covering the upper portion of the cap 22c for holding back rainwater and the like, and preventing the outer cable 22b from being eroded by rainwater. A waterproofing wall 32e is also formed at the case 32a for covering the end portion of a cap 24c and a 25c for holding back rainwater and the like and preventing an outer cable 24b and an outer cable 25b from being eroded by rainwater.

As shown in FIG. 1 and FIG. 2, a connector 33 is formed at the upper portion of the first cover 32b, which is electrically connected to the terminal base. The connector 33 is connected to the harness 34 being electrically connected to the electric control unit (hereinafter called the EUC) (not shown) provided at the vehicle body side.

Next, the operation of the outside handle 21 will be explained. As shown in FIG. 1 and FIG. 2, the outside handle 21 mainly includes a handle frame 40 (inner member) and a handle grip 41 (outer member). The handle frame 40 made of resin is fixed to the vehicle inboard surface (inner surface of the door 11) of the outer panel 14 (outer panel) provided at the vehicle outboard side of the door 11 with screw and the like (not shown) along the longitudinal direction thereof with the longitudinal direction of the vehicle. As shown in FIG. 2, a hole 40a is formed on the front portion (hereinafter called front) of the handle frame, and a hole 40b are formed on the rear portion (hereinafter called rear) of the handle frame 40. The hole 40a and the hole 40b approximately correspond to a hole 14a and a hole 14b on the outer panel 14 respectively.

The hollow hand grip 41 made of resin or metal includes a case and a cover. The handle grip is provided at the vehicle outboard surface of the outer panel 14 (outer surface of the door 11) along the longitudinal direction thereof with the longitudinal direction of the vehicle. In this condition, an arm portion (not shown) formed on the front of the handle grip 41 is inserted through the hole 14a and the hole 40a integrally, and a lever (not shown) formed on the rear of the handle grip 41 is inserted through the hole 14b and the hole 40b integrally. In this way, the handle grip 41 is supported by the handle frame 40. The form or the structure of the handle grip 40 is not limited to the aforementioned configuration. The handle grip 40 can be a grip-shape grip or a pull-up shape grip.

The bell crank 42 is rotatably supported by a shaft 42a (shown in FIG. 1) at the lower portion of the hole 40b of the handle frame 40. The lever portion of the handle grip 41 is engaged with an arm 42b of the bell crank 42. The inner cable 22a of the cable 22 is engaged with the bell crank 42. According to the embodiment of the current invention, the handle grip 41 pivotally moves outwardly in the vehicle width direction at predetermined angle around the arm portion thereof. In response to the rotation of the handle grip 41, the bell crank 42 is rotated on a shaft 42a, as a result, the inner cable 22a is pulled.

An antenna electrode (not shown) and a sensor electrode (not shown) are provided at the hollow portion in the handle grip 41 as components for a so-called smart entry system. The smart entry system allows the door lock apparatus to be unlocked by detecting that a user is approaching to the vehicle and brings his hand toward the outside handle 21. Specifically, the antenna electrode sends a signal at predetermined frequency toward the outside of the vehicle, and the sensor electrode detects that the user brings his hand toward the outside handle 21, based on a difference of an electrical capacitance. The harness 23 is electrically connected to the antenna electrode and the sensor electrode. The antenna electrode and the sensor electrode are electrically connected to the harness 23 which is connected to the terminal base of the door lock apparatus 20 as described later. The terminal base is connected to the ECU through the connector 33 and the harness 34 as described above. Thus, the antenna electrode and the sensor electrode are finally connected to the ECU through the harness 34 and the like.

Next, the configuration of the cable 22 and the harness 23 will be explained. As described above, the bell crank 42 of the outside handle 21 side and the outside open lever 31a of the door lock apparatus 20 side are connected with the inner cable 22a of the cable 22. In other word, the cable 22 transmits the operating force generated by the operation of the handle grip 41 of the outside handle 21 toward the outside open lever 31a.

As shown in FIG. 1 and FIG. 2, one end of the cable 22 connected to the outside handle 21 side is supported at the cap 22c thereof with a supporting arm 40c formed at the handle frame 40. The other end of the cable 22 connected to the door lock apparatus 20 side is supported at the cap 22c thereof with a supporting flange 32f of the second cover 32c. When the outside handle 21 and the door lock apparatus 20 are assembled to the door 11, one end of the cable 22 extends from the supporting arm 40c in downward direction and the other end of the cable 22 extends from the supporting flange 32f in downward direction. The cable 22 extends from the supporting arm 40c in the vertical direction, curves at the middle portion thereof, then further extends in vertical direction toward the supporting flange 32f. Thus, the cable 22 includes the two vertical potions with a curved portion therebetween, so that the cable 22 forms approximately a u-shape form.

Furthermore, the cable 22 extends in vehicle width direction (in the thickness direction of the door 11) at the middle portion. In this configuration, the outside handle 21 is provided at the outer panel 14 of the door 1 1, and the door lock apparatus 20 is provided at vehicle inboard side relative to the outside handle 21. In addition, the outside open lever 31a is located at vehicle inboard side of the door lock apparatus 20, as a result, the cable 22 extends approximately in the thickness direction of the door 11 at the middle portion 22d of the cable 22. Thus, as shown in FIG. 1, the cable 22 has a force for recovering the form thereof from being curved to being straight is in the thickness direction of the door, as a result, the cable 22 is pressed against the outer panel 14 near the outside handle thereof. In this way, the cable 22 is being stably supported by contacting with the outer panel 14, thus the flip-flop movement of the cable 22 in the thickness direction of the door 11 is prevented. In addition, the noise generated by the engagement between the cable 22 and the outer panel 14 can also be prevented. This configuration allows the inner structure of the door 11 to be simpler due to not using a clamp or the like for supporting the cable 22.

A protecting member 26 (protecting member) made of, for example, polyurethane foam, is provided at the contacting portion of the cable 22 with the outer panel 14, so that the cable 22 is not contacting with the outer panel 14 directly. As a result, wear and degradation of the cable 22 can be decreased.

As shown in FIG. 1 and FIG. 2, the harness 23 is provided integrally with the cable 22 by the protecting member 26 and a tape 27. Thus, the harness 23 is easily provided being stably supported with the cable 22 within the door 11.

Next, an assembling process of the door operating apparatus 10 to the door 11 will be explained. As shown in FIG. 4, the door lock apparatus 20 includes a holding portion 35 (supporting member) formed near the latch mechanism 30 and an engaging portion 36 (supporting member) formed integrally with the case 32a. On the other hand, an engaging arm portion 40d is formed at the handle frame 40 of the outside handle 21. The top end of the engaging arm portion 40d extends toward upper direction, then inflects inwardly at 90 degrees and extends in the vehicle width direction. In this configuration, the handle frame 40 can be integrally supported with the door lock apparatus 20 as shown in FIG. 5 and FIG. 6. Specifically, the top end of the engaging arm portion 40d of the handle frame 40 is engaged with the engaging portion 36 of the door lock apparatus 10, and a part of the handle frame 40 held by the holding portion 35.

The door operating apparatus 10 integrally assembled is put into the door 11 through an opening (not shown) formed on the inner panel 12 and fixed with screws on a panel 15 at the rear portion of the door 11, as shown in FIG. 5 and FIG. 6. Then, the handle frame 40 is removed from the door lock apparatus 20 and fixed to the outer panel 14. In this way, it is easy to assemble the door operating apparatus 10 within the door 11 because the door lock apparatus 20 and the handle frame 40 are put into the door 11 integrally. In addition, it is easy to assemble the door operating apparatus 10 in the door 11 because the door lock apparatus 20 and the handle frame 40 are connected with the cable 22 beforehand, and these components are put into the door 11 integrally. Furthermore, it is easy to assemble the door operating apparatus 10 to the door 11 because the cable 22 contacts with the outer panel 14 and is supported within the door 11 stably with the force for returning the form thereof from being curved in being straight.

The operation of the door operating apparatus 10 will be explained. When the lock mechanism 31 of the door lock apparatus 20 is an unlocked condition, the latch mechanism 30 is allowed to rotate by the operating force input into the outside open lever 31a and the inside open lever 31b through the lever and the like. When the handle grip 41 of the outside handle 21 is operated while the lock mechanism 31 has been unlocked, the latch 30a changes a condition thereof from being engaged with the striker to disengaged from the striker. As a result, the door 11 is opened relative to the vehicle body.

On the other hand, when the lock mechanism 31 of the door lock apparatus 20 has been locked, the operating force input into the outside open lever is not transmitted to the latch mechanism 30, as a result, the latch mechanism 30 is not rotated. In other word, when the handle grip 41 of the outside handle 21 is operated while the lock mechanism 31 has been locked, the latch 30a is not rotated, as a result, the door 11 is not opened relative to the vehicle body.

The present invention is not limited only to the aforementioned embodiment. In the embodiment, the harness 23 is connected to the antenna electrode and the sensor electrode; however, another members provided in the handle grip may be adapted to connect the harness 23 alternatively. For example, switches may be provided at the handle grip 41 for switching the door lock apparatus 20 between the locked condition and the unlocked condition or for electrically rotating the latch mechanism 30, and these switches may be adapted to connect the harness 23.

In the embodiment of the present invention, the door 11 is provided on the side surface of the vehicle. However, the door 11 can be provided at the rear of the vehicle. Furthermore, the door 11 can be a slide-type door.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

What is claimed is:

1. A vehicle door operating apparatus operated for opening a vehicle door, comprising:
an opening operation member provided at the vehicle door outside of a compartment and operated for rotating a latch mechanism of the vehicle door relative to a vehicle body from an engaging condition to a disengaging condition;
a vehicle door lock apparatus provided inside of the compartment relative to the opening operation member of the vehicle door and having an unlocked condition that the latch mechanism is rotatable and a locked condition that the latch mechanism is not rotatable based on at least an operation of the opening operation member;
an input member provided at the vehicle door lock apparatus for receiving an operating force from the opening operation member provided inside of the compartment; and
a cable provided for transmitting the operating force from the opening operation member to the input member.

2. A vehicle door operating apparatus according to claim 1, wherein the vehicle door lock apparatus includes an inner cover covering inside of the compartment thereof, and the input member is provided at the inner cover.

3. A vehicle door operating apparatus according to claim 1, wherein the opening operation member includes an inner member fixed to an inner surface of an outer panel of the vehicle door and an outer member provided at an outer surface of the outer panel of the vehicle door and supported by the inner member, and the vehicle door lock apparatus includes a supporting member for supporting the inner member engageably and disengageably.

4. A vehicle door operating apparatus according to claim 1, wherein the cable extends from the opening operation member in vertical direction, curves at a middle portion thereof and further extends in vertical direction toward the vehicle door lock apparatus upon being assembled within the vehicle door.

5. A vehicle door operating apparatus according to claim 1, wherein a protecting member provided at the cable for engaging with the inner surface of the outer panel of the vehicle door.

6. A vehicle door operating apparatus according to claim 1, wherein a wire harness supported with the cable for electrically connecting the opening operation member side and the vehicle door lock apparatus side.

7. A vehicle door operating apparatus according to claim 1, wherein the inside of the compartment means the inside relative to a first shaft rotatably supporting the latch mechanism, and the outside of the compartment means the inside relative to the first shaft.

8. A vehicle door operating apparatus according to claim 4, wherein the cable forms approximately a U-shape form from in cross-sectional view including the two vertical portions extending from the opening operation member and the vehicle door lock apparatus and the curved portion extending in thickness direction of the vehicle upon being assembled within the vehicle door.

9. A vehicle door operating apparatus according to claim 3, wherein the operation force is generated due to a pivotally movement of the outer member in outward direction and transmits to the input member through the cable for rotating the latch mechanism.

10. A vehicle door operating apparatus according to claim 1, wherein the input member is a lever-type member rotatably supported by a second shaft extending in approximately the thickness direction of the vehicle door and rotated inside of the compartment relative to the first shaft.
